(19) United States
(12) Patent Application Publication
(10) Pub. No.: US 2014/0226433 A1
(43) Pub. Date: Aug. 14, 2014

(54) VALVE FOR MIXING APPARATUS

(71) Applicant: MARION MIXER, INC., Marion, IA (US)

(72) Inventors: Thomas L. Ternes, Mt. Vernon, IA (US); Douglas E. Grunder, Mt. Vernon, IA (US)

(73) Assignee: Marion Mixer, Inc., Marion, IA (US)

(21) Appl. No.: 13/764,830

(22) Filed: Feb. 12, 2013

(51) Int. Cl. B01F 15/02; F16K 31/524

(52) U.S. Cl. CPC B01F 15/0292; F16K 31/52408
USPC 366/192; 251/251; 251/318

(57) ABSTRACT

A valve structure is provided for controlling the discharge flow from a mixing apparatus. The mixing apparatus includes a mixing bowl with a discharge opening therein. The valve includes a paddle member dimensioned to conform to and close the discharge opening in the mixing bowl. A first actuator is provides for selectively moving the paddle member between a closed position, wherein the paddle member overlaps and covers the discharge opening, and an open position, wherein the paddle member is displaced from covering the discharge opening. A second actuator mechanism is provided for selectively moving the paddle member into a sealing engagement with the bowl discharge opening, when the paddle member is in the closed position, and displaced from engagement with the bowl opening, prior to movement of paddle member to the open position by the first actuator.

### FIELD OF THE INVENTION

The present disclosure relates to a discharge valve for use in a mixing apparatus or a similar device. The mixing apparatus may be used for the processing of a particulate material, a liquid or slurry and may include the application of microwave energy within the process.

### BACKGROUND

It is known to use microwave energy to heat a product on a continuous or batch basis, where the product is a particulate material, a liquid or slurry. The heating may be performed fur the purpose of cooking the product, reducing the moisture content of the product or to otherwise process the product. After completion of the processing, the processed material is discharged from the processing apparatus and transported away from the apparatus for further processing or storage.

US 2010/0132210 to Kruger shows an apparatus with mixing blades positioned in a horizontal bowl. A heating device is used in the process, with microwave energy being one option for supplying heat to the product. A discharge opening is provided on an end wall of the apparatus, which is closed by a pivoting flap.

U.S. Pat. No. 4,882,851 to Wennerstrum et al shows a device for batch drying of a powdered or particulate product by, means of a microwave vacuum, system. The device includes a vacuum means to withdraw liquid from the process chamber. An agitator is provided in the drying chamber. Discharge of the dried particulate is accomplished by rotation of the mixing container to dump the processed material through a discharge chute or the like.

U.S. Pat. No. 5,400,524 to Crosnier Leconte et al shows a device for drying a granular or powdered product having a dielectric duct with a microwave applicator therein. A rotating metal screw is positioned in the duct to convey the product. The screw includes at least one helically wound wire that extends along the duct and is spaced from the duct wall.

U.S. Pat. No. 5,857,264 to Debolini shows a dryer for a powdered product having a mixer within a drying chamber. The mixer includes a series of paddle blades mounted on a shaft that is eccentrically positioned within the drying chamber. An outlet is provided in an end wall for discharge of the processed product.

### SUMMARY OF THE INVENTION

The present disclosure relates to a valve for controlling the discharge flow from a mixing apparatus or the like. The mixing apparatus includes a chamber defined by a mixing bowl and a discharge opening in the mixing bowl. The valve includes a paddle member dimensioned to close and to conform to the discharge opening in the mixing bowl. A first actuator selectively moves the paddle member between a closed position and an open position. In the closed position, the paddle member overlaps and covers the discharge opening. In the open position, the paddle member is displaced from covering the discharge opening. A second actuator mechanism is provided for selectively moving the paddle member into a sealing engagement with the bowl discharge opening, when the paddle member is in the closed position of the first actuator. The second actuator mechanism also displaces the paddle member from engagement with the bowl opening, prior to movement of paddle member to the open position by the first actuator.

In a further aspect of the disclosure, a valve housing is provided that surrounds and encloses the paddle member during its movement between the open and closed positions. The housing includes a valve discharge opening that is in communication with the bowl discharge opening when the paddle member is in the open position.

In a further aspect of the disclosure, means may be provided for attaching the valve housing to the mixing bowl. The valve attaching means may releasably attach the housing to the mixing bowl. Further, the valve attaching means may pivotably secure the housing to the mixing bowl.

In a further aspect of the disclosure, the first and second actuators may be attached to the housing and positioned outwardly of a housing wall. The first and second actuators preferably communicate with the paddle member through the housing wall. Further, the first actuator preferably moves the paddle member linearly and transverse to the discharge opening. The second actuator preferably rotates a cam shaft having an eccentric surface thereon. The eccentric surface preferably moves the paddle member between the engaged and displaced positions with the discharge opening. The eccentric surface may be provided in the form of a tab attached to the cam shaft. The second actuator mechanism may include two actuator members, each rotating a cam member into contact with the paddle member. The two actuator members are synchronized to engage their eccentric cam surfaces against the paddle in a manner that equalizes the sealing force of the paddle against the discharge opening.

In a still further aspect of the disclosure, a further actuator may be provided for assisting the second actuator in selectively moving the paddle member into a sealing engagement with the bowl discharge opening. The actuator preferably rotates a further cam shaft having an eccentric surface thereon for engaging the paddle member for moving the paddle member between the engaged and displaced positions with the discharge opening.

In a further aspect of the disclosure a mixing apparatus is provided having a mixing bowl and valve structure. The mixing bowl includes a bowl wall defining a mixing chamber, and a discharge opening in the mixing bowl. The valve structure is releasably attached to the mixing bowl and covering the discharge opening. The valve structure includes a paddle member dimensioned to close the discharge opening and formed to conform to the mixing bowl adjacent the discharge opening. A valve housing is provided and surrounds and enclosing the paddle member. The housing includes a valve discharge opening in communication with the bowl discharge opening. A first actuator is provided for selectively moving the paddle member between a closed position, wherein the paddle member overlaps and covers the discharge opening, and an open position wherein the paddle member is displaced from covering the discharge opening. A second actuator mechanism is provided for selectively moving the paddle member into a sealing engagement with the bowl discharge opening. This selective movement occurs when the paddle member is in the closed position of the first actuator. The paddle member is further displaced from engagement with the bowl opening, prior to movement of paddle member to the open position by the first actuator.

Other features of the present invention and combinations of features will become apparent from the detailed description to follow, taken in conjunction with the accompanying drawings.

### BRIEF DESCRIPTION OF THE DRAWINGS

For the purpose of illustrating the invention, the drawings show one or more forms that are presently preferred. It should be understood that the invention is not limited to the precise arrangements and instrumentalities shown in the drawings.

FIG. 1 shows an elevation view of a mixing apparatus with certain internal structures of the mixer bowl and the agitator being shown in phantom and a discharge valve provided on an underside of the mixer.

FIG. 2 shows an enlarged view in cross section of a portion of the mixing apparatus and a discharge valve structure.

FIG. 3 shows a top plan view of the internal structures of the discharge valve, with the valve plate shown in an open position.

FIG. 4 shows a perspective view of the discharge valve with structure elements being exploded from the main valve body.

FIG. 5 shows a side elevation of the discharge valve as mounted on a bottom surface of the mixer (shown in cross section), with a secondary pivoted position for the valve structure shown in phantom.

### DETAILED DESCRIPTION

In the figures, where like numerals identify like elements, there is shown an embodiment of a mixer or mixing apparatus generally designated by the numeral 10. The mixer 10 includes a bowl 12 supported by legs 14. As shown, wheels are provided on the legs, making the mixer 10 portable. The mixer 10 defines a closed mixing chamber formed by the bowl 12 and a hinged cover or lid 16. The lid 16 closes an access opening 22 into the bowl 12. A series of ports (not shown) may be provided for access into (and out of) the chamber defined by the bowl. A further port may be provided for the introduction of microwave energy into the chamber. The further port may be connected to a duct, which is further connected to a wave guide or generator (not shown) for supplying the microwave energy into the chamber. In addition, a material source may be introduced into the chamber via one of the provide ports. An agitator 18 (shown in phantom) is provided within the mixing chamber. The agitator 18 as shown includes a series of paddles mounted on a rotational shaft that extends the length of the bowl 12 and is driven by a motor 20 attached at one end of the mixer 10. Other forms of agitators may be provided, including a ribbon conveyor, flat blades or other structures.

The mixer 10 as shown is for batch processing of product, as compared to the continuous processing of product. The lid 16 is provided to cover an inlet opening 22. The lid 16 pivots with respect to the bowl 12 by means of a hinge to expose the opening 22. The bowl 12 is preferably asymmetrical in that there is a rounded bottom or base portion 24 and extended, generally rectangular top portion 26. The agitator 18 is positioned within the base portion 24 of the bowl 12. The agitator paddles are rotated about the shaft and are positioned closely adjacent the curved bottom of the base 24 of the bowl 12. The direction of rotation and the rotational speed of the agitator 18 may vary for purposes of mixing and discharge from the bowl. For example, it may be advantageous for the rotation to be reversed during one or more portions of the product processing. Alternatively or in addition thereto, the agitator rotation may be stopped during a portion of the process. The product being processed within the mixer, the form of the agitator and the timing of the microwave energy are three of the potential parameters that may affect the speed and direction of the agitator.

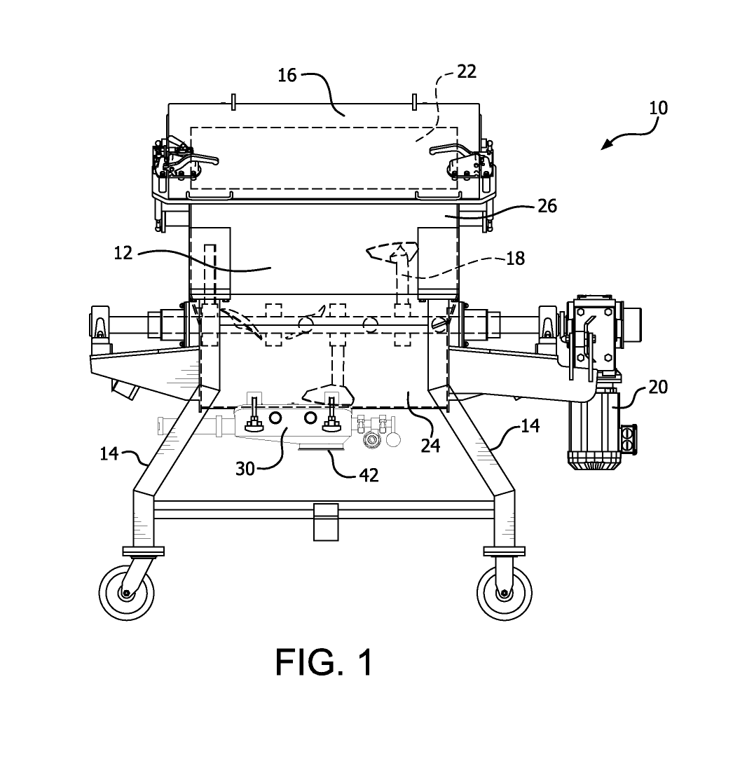

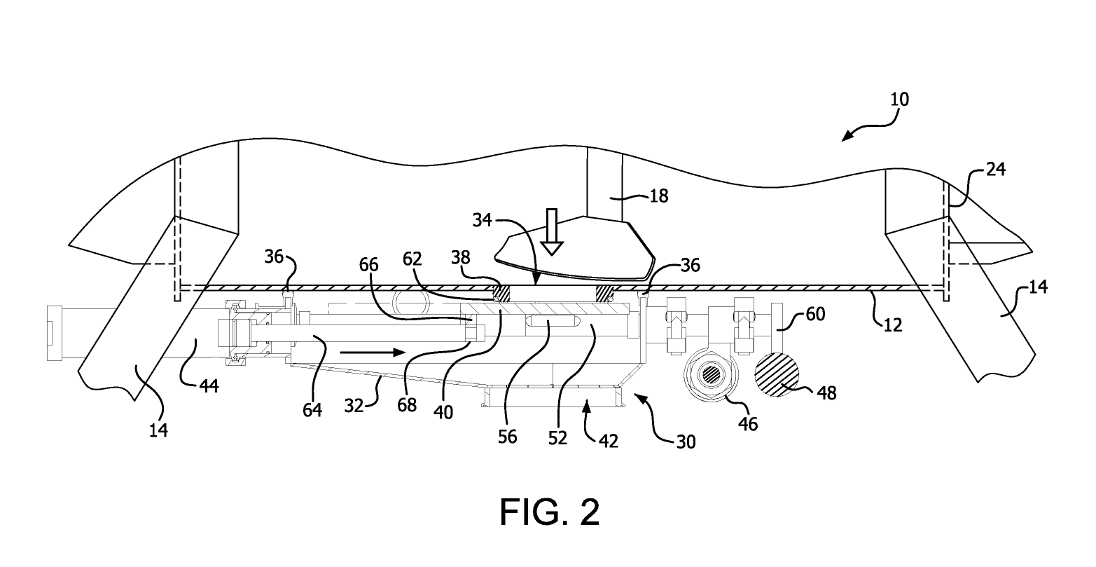

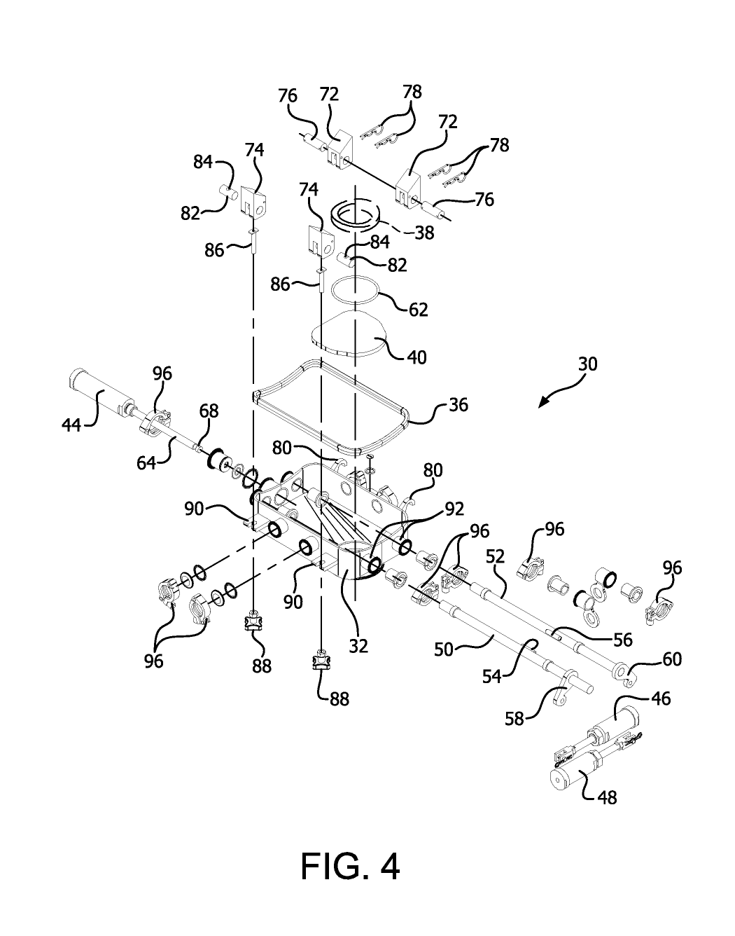

A discharge valve 30 is provided on the base 24 of the bowl 12. The valve 30 is generally shown in FIG. 1 and is removably attached to the underside surface of the base 24 of the mixer bowl 12. In the cross section of FIG. 2, the valve is shown to include a housing 32 that engages the outside surface of the bowl 12 and is sealed thereto by a gasket 36. The housing 32 surrounds a discharge opening 34 formed in the wall of the bowl 12. The opening 34 communicates with the interior of the bowl 12. The opening 34 is defined by a peripheral flange 38. A paddle plate 40 is provided within the valve housing 32 and seals with the flange 38 to close the discharge opening 34. As described in further detail herein, the plate 40 is movable out of engagement with the flange 38 to permit material to pass through the discharge opening 34 and out through a valve opening 42 at the base of the housing 32. The structural elements of the valve 30 are shown in an exploded formation in FIG. 4.

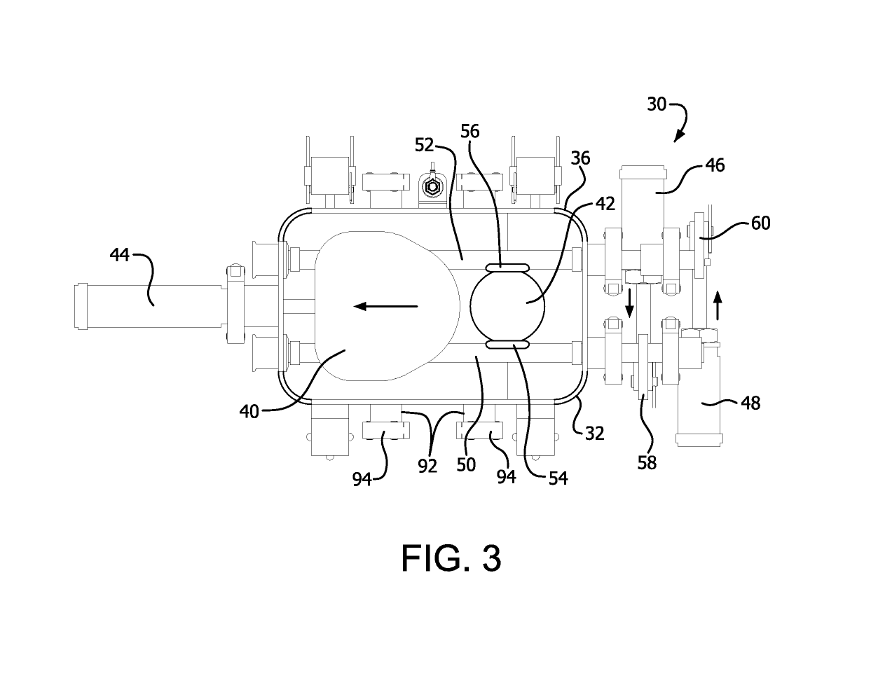

Movement of the plate 40 within the valve 30 is created by a first or linear actuator 44 and a second actuator mechanism formed by a pair of cam actuators 46, 48. The linear actuator 44 moves the plate laterally between the bowl sealing position, as shown in FIG. 2, and the discharge position, as shown in FIG. 3. The cam actuators 46, 48 are provided for moving the plate 40 vertically into a sealing engagement with the flange 38 surrounding the bowl opening 34.

The cam actuators 46, 48 of the second actuator mechanism respectively rotate the cam shafts 50, 52 positioned within the housing 32. Attached to the cam shafts 50, 52 are cam tabs 54, 56. The tabs 54, 56 form eccentric surfaces that contact the underside of the plate when the cam shafts 50, 52 are rotated into position by their corresponding actuators 46, 48. The actuators 46, 48 are positioned on the outside of the housing 32. Linkage 58, 60 is respectively attached to each actuator 46, 48 to translate the linear movement of the actuators 46, 48 into rotational movement of the cam shafts 50, 52. The actuators 46, 48 are oppositely positioned and rotate the two cam shafts 50, 52 in opposite directions. Rotation of the shafts 50, 52 move their corresponding tabs 54, 56 into and out of contact with the bottom of the plate 40. The second actuator mechanism preferably synchronizes the rotating of the two cam members into contact with the paddle member. However, the amount of travel for each cam is contemplated to be independent and each may be adjusted as desired. Preferably, the two actuators engage the paddle in a manner that equalizes the sealing force of the paddle around the circumference of the discharge opening. Other forms of activation of the plate to seal with the flange and the discharge opening are possible and will be recognized upon review of the present disclosure.

In FIG. 2, the actuators 46,-48 are in their retracted position, rotating the shafts 50, 52 (with only shaft 52 shown after the cross section of the housing) such that the tabs 54, 56 (with only tab 54 shown in the cross sectional view) engage the plate 40 and move it into engagement with the flange 38 A gasket 62 may be provided on the flange 38 to enhance the sealing engagement between the plate 40 and the flange 38. Vertical movement of the plate 40 relative to the actuator shaft 64 that extends from the linear actuator 44 is permitted by a connection adjusting means. The adjusting means is shown to be formed by a projecting hook member 66 formed on the underside of the plate 40 (shown in cross section in FIG. 2) and an engagement tip 68 on the end of the shaft 64, forming a receiving groove. The hook member 66 forms a slot in which the engagement tip is inserted. The slot permits the plate 40 to move vertically while the shaft tip 68 remains laterally engaged with the hook 66. Other forms of engagement the permit the plate to move vertically during its sealing activation motion are possible and will be recognized upon review of the present disclosure.

in FIG. 3, the actuators 46, 48 are operated to extend, rotating the shafts 50, 52 to remove the sealing force caused by the earn tabs 54, 56. As the tabs 54, 56 are moved away from forcing the plate 40 into sealing engagement with the flange 38, the linear actuator 44 is activated to retract and withdraw the plate 40 from under the flange 38. As the plate is moved to the open position, the material within the bowl 12 of the mixer 10 may move out of the discharge opening 34, through the valve housing 32, and out of the valve opening 42. A transport bin or connecting conduit (not shown) may be provided to move the discharged material to a new location from further processing.

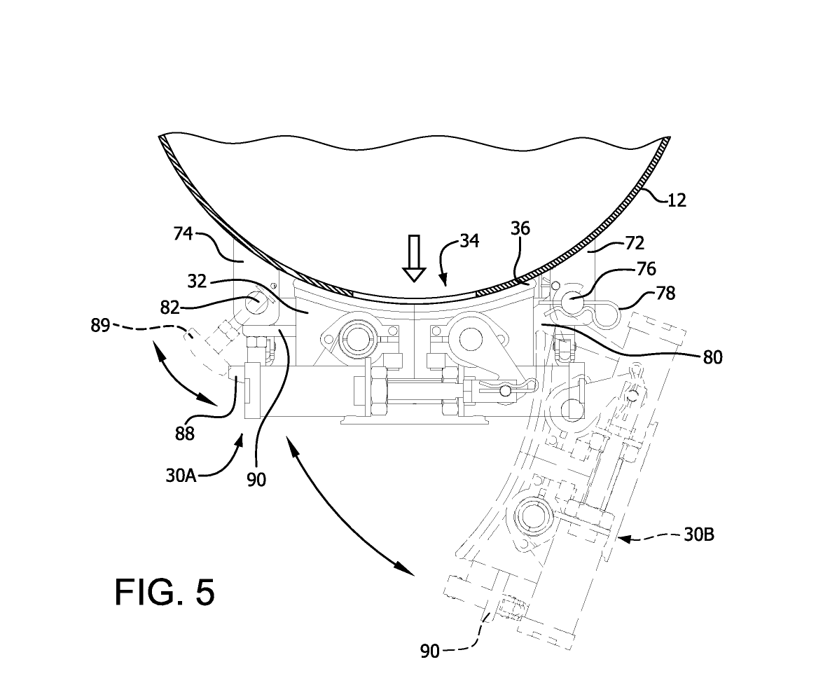

In FIG. 5 there is shown the releasable attachment of the valve 30 to the bowl 12 of the mixer 10. In the first or sealed position of the valve 30A, the housing 32 is fixed to the underside of the bowl 12 and sealed by gasket 36. The structure of attachment means is also shown in FIG. 4. Pivot brackets 72 attached to the bowl wall are positioned on one side of the housing 32 and connector brackets 74 are positioned on the opposing side. Release of the connection of the housing to the connector brackets permits the housing 32 to pivot about its connection to the pivot brackets 72 into the valve position 30B. The valve may then be removed from the bowl or otherwise accessed.

The pivot brackets 72 each include a pivot shaft 76 and removable pins 78 to hold the shaft in place. Projecting hooks 80 are formed on the outside of the housing 32. The hooks 80 fit within slots formed in the body of the brackets 72 and wrap over the pins 78. A lock may be provided to assist in fixing the position and engagement of the hooks with the brackets.

The connector brackets 74 each include a shaft 82 have a hole 84 therein that aligns with a slot within the bracket body. A screw shaft 86 is inserted into the hole 84 in the shaft 82 and projects from the bracket body. Threads are provided on the end of the screw shaft and are engaged by a thumb nut 88. A projecting tab 90 is formed on the outside of the housing 32 and includes a slot for receipt of the screw shaft 86. The thumb nut 88 engages the tab 90 and, upon tightening, secures the housing 32 to the bowl wall. Un-tightening the thumb screws 88 permits the screw shaft to be rotated away from the tab 90 to release the housing 32 and permit pivoting of the valve to position 30B. Other forms of securing and sealing the valve housing to the bowl around the discharge opening are possible and will be recognized upon review of the present disclosure,

Various openings and flanges are shown to be formed and attached to the housing 32 of the valve 30 and their structures detailed in FIG. 5, among other places. A plurality of sanitary fittings 92 are provided on the sidewalls of the housing 32 and include sealing end caps 94 thereon. The end caps 94 may be selectively removed for access to the interior of the housing, including the paddle member 20. The fittings 92 may also support a variety of sensors, clean-in-place equipment, input devices, etc. Tri-clamps 96 are shown as forming the seal for various structures, including the cam shafts 50, 52 and actuator 44.

The valve structure as described and shown is contemplated to be applicable to a number of apparatus and is not limited to mixing apparatus. In the presently contemplated structure, the paddle is formed as a flat plate, with the projected end of the flange being machined to form matching flat engagement surface. Preferably, the plate of the paddle and the tubular flange are formed of metal. The flange may include a machined groove therein for receipt of an o-ring (or similar) gasket to add to the sealing of the paddle to the flange.

In the preferred application, the mixing apparatus may further process the contents by heating, including the use of microwave energy as part of the heating or processing of the product, A microwave or other energy source may be directed into the bowl through a flanged inlet (not shown) that surrounds a projected portion of the bowl. The fittings and sealing structures of the valve are contemplated to be formed in a way to form a microwave choke and thus deter or prevent microwave leakage from the bowl. The flat—metal-on-metal—seal arrangement between the paddle member and the flange surrounding the discharge opening is sufficient to choke or prevent microwave leakage, particularly when the product is filled in the bowl. The addition of the (o-ring) gasket is contemplated to further seal the bowl opening within applications involving liquid or slurries. The gasket may also be effective in sealing the bowl in pressurized or vacuum applications.

The present disclosure includes a description and illustration of various exemplary embodiments. It should be understood by those skilled in the art from the foregoing that other changes, omissions and additions may be made, without departing from the spirit and scope of the invention, with the invention being identified by the foregoing claims.

What is claimed is:

1. A valve for controlling the discharge flow from a mixing apparatus, the mixing apparatus having a chamber defined by a mixing bowl and a discharge opening in the mixing bowl, the valve comprising:
a paddle member dimensioned to conform to and close the discharge opening in the mixing bowl;
a first actuator for selectively moving the paddle member between a closed position, wherein the paddle member overlaps and covers the discharge opening, and an open position wherein the paddle member is displaced from covering the discharge opening; and
a second actuator for selectively moving the paddle member into a sealing engagement with the bowl discharge opening, when the paddle member is in the closed position of the first actuator, and displaced from engagement with the bowl opening, prior to movement of paddle member to the open position by the first actuator.

2. A valve as in claim 1 further comprising a valve housing surrounding and enclosing the paddle member during its movement between the open and closed positions, the housing having a valve discharge opening in communication with the bowl discharge opening when the paddle member is in the open position.

3. A valve as in claim 2 further comprising means for attaching the valve housing to the mixing bowl.

4. A valve as in claim 3 wherein the valve attaching means releasably attaches the housing to the mixing bowl.

5. A valve as in claim 4 wherein the valve attaching means further pivotably secures the housing to the mixing bowl.

6. A valve as in claim 2 wherein the first and second actuators are attached to the housing and positioned outwardly of a housing wall, the first and second actuators communicating with the paddle member through the housing wall.

7. A valve as in claim 1 wherein the first actuator move the paddle member transverse to the discharge opening.

8. A valve as in claim 7 wherein the first actuator linearly moves the paddle member.

9. A valve as in claim 1 wherein the second actuator rotates a cam shaft having a eccentric surface thereon, the eccentric surface engaging the paddle member for moving the paddle member between the engaged and displaced positions with the discharge opening.

10. A valve as in claim 9 wherein the eccentric surface is a tab attached to the cam shaft.

11. A valve as in claim 9 further comprising a further actuator for assisting the second actuator in selectively moving the paddle member into a sealing engagement with the bowl discharge opening, the second actuator rotating a further cam shaft having a eccentric surface thereon for engaging the paddle member for moving the paddle member between the engaged and displaced positions with the discharge opening.

12. A mixing apparatus comprising:
a mixing bowl, the mixing bowl having a bowl wall defining a mixing chamber, and a discharge opening in the mixing bowl; and
a valve structure releasably attached to the mixing bowl and covering the discharge opening, the valve structure having
a paddle member dimensioned to close the discharge opening and formed to conform to the mixing bowl adjacent the discharge opening,
a valve housing surrounding and enclosing the paddle member, the housing having a valve discharge opening in communication with the bowl discharge opening,
a first actuator for selectively moving the paddle member between a closed position, wherein the paddle member overlaps and covers the discharge opening, and an open position wherein the paddle member is displaced from covering the discharge opening, and
a second actuator for selectively moving the paddle member. into a sealing engagement with the bowl discharge opening, when the paddle member is in the closed position of the first actuator, and displaced from engagement with the bowl opening, prior to movement of paddle member to the open position by the first actuator.

13. A mixing apparatus as in claim 12 wherein the first and second actuators are attached to the housing and positioned outwardly of a housing wall, the first and second actuators communicating with the paddle member through the housing wall.

14. A mixing apparatus as in claim 12 wherein the first actuator linearly moves the paddle member transverse to the discharge opening.

15. A mixing apparatus as in claim 12 wherein the second actuator rotates a cam shaft having a eccentric surface thereon, the eccentric surface engaging the paddle member for moving the paddle member between the engaged and displaced positions with the discharge opening.

16. A mixing apparatus as in claim 15 further comprising a further actuator for assisting the second actuator in selectively moving the paddle member into a sealing engagement with the bowl discharge opening, the second actuator rotating a further cam shaft having a eccentric surface thereon for engaging the paddle member for moving the paddle member between the engaged and displaced positions with the discharge opening.

17. A mixing apparatus as in claim 12 wherein the mixing bowl is horizontally positioned and the discharge opening is formed in bottom surface of the bowl wall.

18. A mixing apparatus as in claim 17 further comprising a rotating agitator positioned transverse within the horizontally positioned bowl.

19. A mixing apparatus as in claim 12 wherein the discharge opening includes a peripheral flange, and wherein the paddle member engages and conforms to the flange in the close position.

20. A mixing apparatus as in claim 12 wherein the valve housing is pivotably attached to the bowl wall.
